(19) United States
(12) Patent Application Publication
(10) Pub. No.: US 2006/0062956 A1
(43) Pub. Date: Mar. 23, 2006

(54) Adhesive note with multiple attachment points

(76) Inventors: Ashok Chandaria, Nairobi (KE); Velji Chandaria, Nairobi (KE)

Correspondence Address: SAND & SEBOLT, AEGIS TOWER, SUITE 1100, 4940 MUNSON STREET, NW, CANTON, OH, 44718-3615, US

(21) Appl. No.: 10/947,728

(22) Filed: Sep. 23, 2004

(51) Int. Cl. G09F 3/00

(52) U.S. Cl. 428/43

(57) ABSTRACT

An adhesive note comprising a sheet with an adhesive region on its rear surface and including a line of perforations passing through the adhesive region. The sheet may be divided along the line of perforations to form two smaller sections which each have an adhesive area on their rear surface. Each smaller section may be adhered to an outer surface of an object by the adhesive area on its rear surface. Furthermore, the adhesive note may be provided with more than one line of perforations which pass through the adhesive region, thus enabling the sheet to be separated into a plurality of smaller sections. Each smaller section has an adhesive area on its rear surface. Alternatively, the sheet may be provided with more than one adhesive region. The plurality of adhesive regions may be applied to the rear surface of the sheet on either side of the line of perforations. Additionally, more than one line of perforations can intersect the plurality of adhesive regions to enable the adhesive note to be separated into a plurality of smaller sections which include an adhesive area on their rear surfaces.

### BACKGROUND OF THE INVENTION

1. Technical Field

This invention generally relates to adhesive notepaper. More particularly, the invention relates to notepaper which includes an adhesive region at one end for attaching the notepaper to the outer surface of an object. Specifically, the invention relates to an adhesive note having lines of perforations along which the note can be torn to form separate smaller sections and these include an adhesive area for attaching the smaller section to an object.

2. Background Information

Adhesive notepads are frequently used in business settings for writing brief notes relating to files or documents, for writing reminders and numerous other applications. The sheets of these notepads, or sticky notes as they are frequently referred to, each have an adhesive region applied to their rear surface, proximate the upper edge of the same. When a consumer wishes to use one of the sheets from the notepad, they grasp a lower corner of the sheet and pull it free from the pad. The sheet is then applied to an outer surface of an object by pushing the adhesive region into contact with that outer surface.

The adhesive notepads presently manufactured come in a range of sizes, ranging from about 1 inch×1.5 inches to about 3 inches×5 inches in size. The notepads are sold in prepackaged quantities of 10-20 pads, all of the same size. A consumer may purchase a number of different packages of notepads to provide them with a range of sizes of notepaper for their use. However, it is typical that the consumer selects only that size of notepaper that suites their customary needs. When the consumer is involved in their day to day work, they will utilize the adhesive notes to write down small quantities of information—such as a phone number, or larger quantities of information, such as a message. Depending on the quantity of information they will need to write down, they select the appropriate size notepad. However, periodically the consumer will run out of the most appropriate size of notepad and, after that, if the quantity of information to be written is small, they may have to use a notepad where the sheets are larger than necessary. This is both a waste of paper and a waste of money. The consumer can tear a small piece of the notepaper from the sheet and write the small amount of information onto that smaller piece. However, the problem with this scenario is that the smaller piece generally does not have any of the adhesive on it and therefore cannot be stuck onto the outer surface of an object—it can only be used as a small piece of regular paper. Even if the consumer organizes the tearing of the notepaper so that a small amount of adhesive is present on the rear surface of the torn-off section, when that section is adhered to an object, it tends to look unprofessional.

There is therefore a need in the art for an adhesive type notepad which allows larger notepad sheets to be separated into smaller sheets which include and adhesive on their rear surface and can be adhered to the outer surface of an object and look neat and professional.

### SUMMARY OF THE INVENTION

An adhesive note comprising a sheet with an adhesive on its rear surface and including a line of perforations cutting through the adhesive. The sheet may be divided along the line of perforations to form at least two smaller sections of paper which each have some adhesive on their rear surface. Each smaller section may be adhered to an outer surface of an object by the adhesive on its rear surface. Furthermore, the adhesive note may be provided with more than one line of perforations which cut through the adhesive, thus enabling the sheet to be separated into a plurality of smaller sections. Each of the smaller sections has some adhesive on its rear surface. Alternatively, the sheet may be provided with more than one adhesive region. The plurality of adhesive regions may be applied to the rear surface of the sheet on either side of the line of perforations. Additionally, more than one line of perforations can intersect the plurality of adhesive regions to enable the adhesive note to be separated into a plurality of smaller sections. The consumer can tear the needed size of paper from the adhesive note along the related lines of perforations and, because that smaller section includes adhesive on its rear surface, the smaller section can be stuck to an object and utilized as a sticky note.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is perspective view of an adhesive notepad incorporating a first embodiment of an adhesive note which has a horizontal row of perforations therein, the horizontal row being disposed substantially parallel to the upper edge of the note;

FIG. 2 is a rear view of an adhesive note from the notepad of FIG. 1 showing a first adhesive region proximate the upper edge of the note and a second adhesive region disposed below the row of perforations;

FIG. 3 is a front view of the note of FIG. 2 showing the adhesive note separated into halves along the perforations, thereby forming two smaller sections which each include an adhesive region for adhering the section to an object;

FIG. 4 is a rear view of a second embodiment of the adhesive note in accordance with the present invention in which the note includes a vertical row of perforations disposed substantially at right angles to the upper edge of the note;

FIG. 5 is a rear view of a third embodiment of the adhesive note in accordance with the present invention in which the note includes both a vertical and a horizontal row of perforations which enable the note to be divided into quarters;

FIG. 6 is a front view of the adhesive note of FIG. 5 showing a quarter of the note being removed therefrom and thereby forming a smaller section which includes an adhesive area that allows the smaller section to adhere to an object;

FIG. 7 is a rear view of an adhesive note of a size larger than the note shown in FIGS. 1-6 having an adhesive region proximate the note's upper edge and a vertical row of perforations along the note's midline which allow the note to be divided into halves each having an adhesive area thereon;

FIG. 8 is a rear view of a larger adhesive note that has two vertical rows of perforations that enable the note to be divided into three smaller sections each having an adhesive area thereon; and

FIG. 9 is a rear view of a larger adhesive note having two vertical rows of perforations and one horizontal row of perforations that enable the note to be divided into six smaller sections each having an adhesive area thereon.

### DETAILED DESCRIPTION OF THE INVENTION

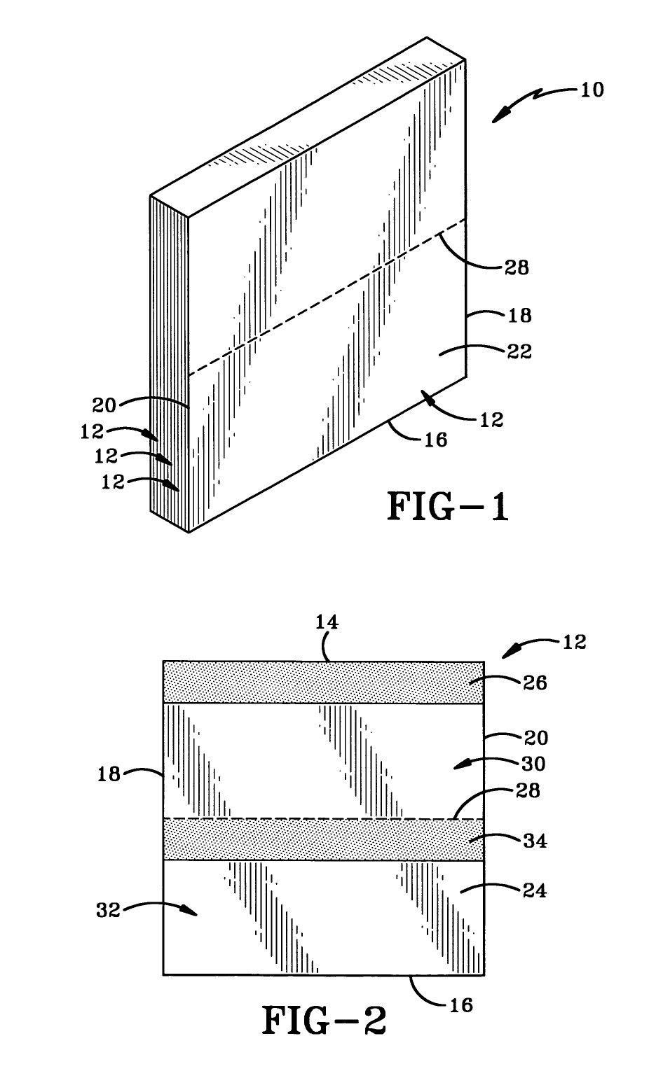

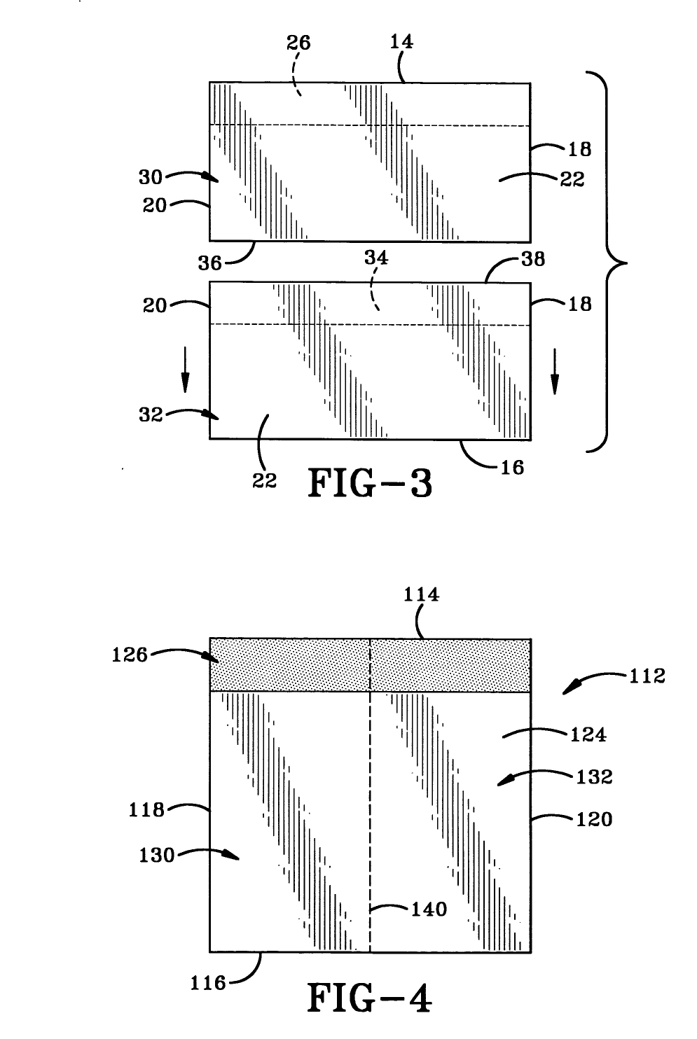

Referring to FIGS. 1-3, there is shown an adhesive notepad 10 made up from a plurality of individual adhesive notes 12. Each adhesive note 12 has an upper edge 14, a lower edge 16, sides 18, 20 a front surface 22 and a rear surface 24. As is well known in the art, an adhesive region 26 is disposed on rear surface 24 of each adhesive note 12, proximate upper edge 14 thereof. Upper edges 14 of the plurality of individual adhesive notes 12 are connected together in any suitable manner known in the art.

In accordance with the present invention, each adhesive note 12 is provided with a line of perforations 28 and may be separated along said perforations 28 to form smaller sections 30, 32. A second adhesive region 34 is provided proximate perforations 28. FIGS. 1-3 illustrate a first embodiment of adhesive note in which perforations 28 lie substantially parallel to upper edge 14 and are horizontally oriented along the center line of note 12.

In use, note 12 may be separated along perforations 28 into two smaller sections 30, 32. Sections 30 and 32 are shorter than note 12, but are of the same width. Section 30 has a new bottom edge 36 and has adhesive region 26 disposed proximate upper edge 14. Section 32 has a new top edge 38 with adhesive region 34 disposed proximate thereto. Each of section 30 and 32 is one half the size of note 12 and, because of adhesive regions 26 and 34 respectively, each section may be individually attached to a remote object (not shown). The consumer may write on the entire note 12 and then tear the note 12 into halves to form sections 30 and 32. Sections 30 and 32 may then be individually attached to separate objects or to different locations on the same object. Alternatively, the consumer may write on lower section 32 only, separate section 32 from section 30 along perforations 28 and stick section 32 onto a remote object, leaving blank section 30 for later use. Alternatively, note 12 may be divided into sections 30 and 32, those sections may be stuck to remote objects and then written on by the consumer. The consumer therefore does not need to use a full adhesive note 12 onto which to write only a small amount of information, they may utilize only a part of that note 12 for the small amount of information and can use the remaining part of the note at a later stage. If a larger note is needed it need not be torn at all. Therefore adhesive note 12 provides the flexibility of having a full size note or one of reduced size. Both the full size note and the reduced size note have an adhesive region by which to adhere the note to a surface.

FIG. 4 illustrates a second embodiment of adhesive note in accordance with the present invention and indicated generally at 112. Similarly to note 12, adhesive note 112 has an upper edge 114, a lower edge 116, side edges 118, 120, a front surface (not shown) and a rear surface 124. A vertical row of perforations 140 are provided so as to enable note 112 to be separated into two smaller sections 130, 132. However, in this second embodiment of the invention, perforations 140 are oriented substantially perpendicular to upper edge 114 and generally along the midline of the note 112. An adhesive region 126 is provided on rear surface 124 of note proximate upper edge 114 and extending from side 118 to side 120. When note 112 is separated along perforations 140, two long narrow sections 130, 132 are formed. Each section 130, 132 includes half of the adhesive region 126, namely areas 126a and 126b. These areas 126a, 126b of adhesive allow each smaller section 130, 132 to be individually attached to an outer surface of a remote object (not shown).

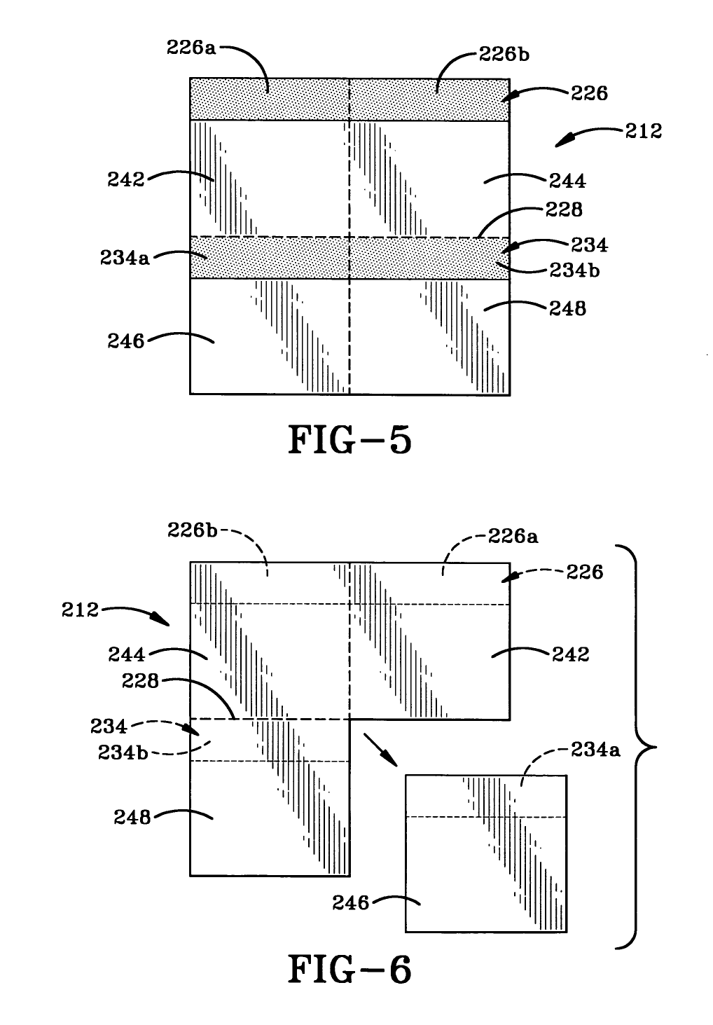

A third embodiment of the adhesive note of the present invention is shown in FIGS. 5 & 6 and generally indicated at 212. As with the first embodiment, note 212 is provided with a horizontal row of perforations 228 and two adhesive regions 226, 234. Note 212 is also provided with a vertical row of perforations 240. The provision of the two perpendicular rows of perforations 228, 240, in combination with the adhesive regions 226, 234 allows note 212 to be divided into four sections 242, 244, 246 and 248 which are one quarter the size of note 212. Each section 242, 244, 246 and 248 includes a section of adhesive region, namely 226a, 226b, 234a and 234b respectively. Each of the four smaller sections may be individually removed from note 212, written on and adhered to an outer surface of a remote object (note shown). As is illustrated in FIG. 6, each smaller section, such as section 246, may be individually separated from note 212 as and when needed, leaving the remaining portion of note 212 intact until it is needed. It will be understood that note 212 can be used by removing one, two or three of the smaller sections at the same time so that the writing surface separated from note 212 is one quarter, one half or three quarters the size of the note 212.

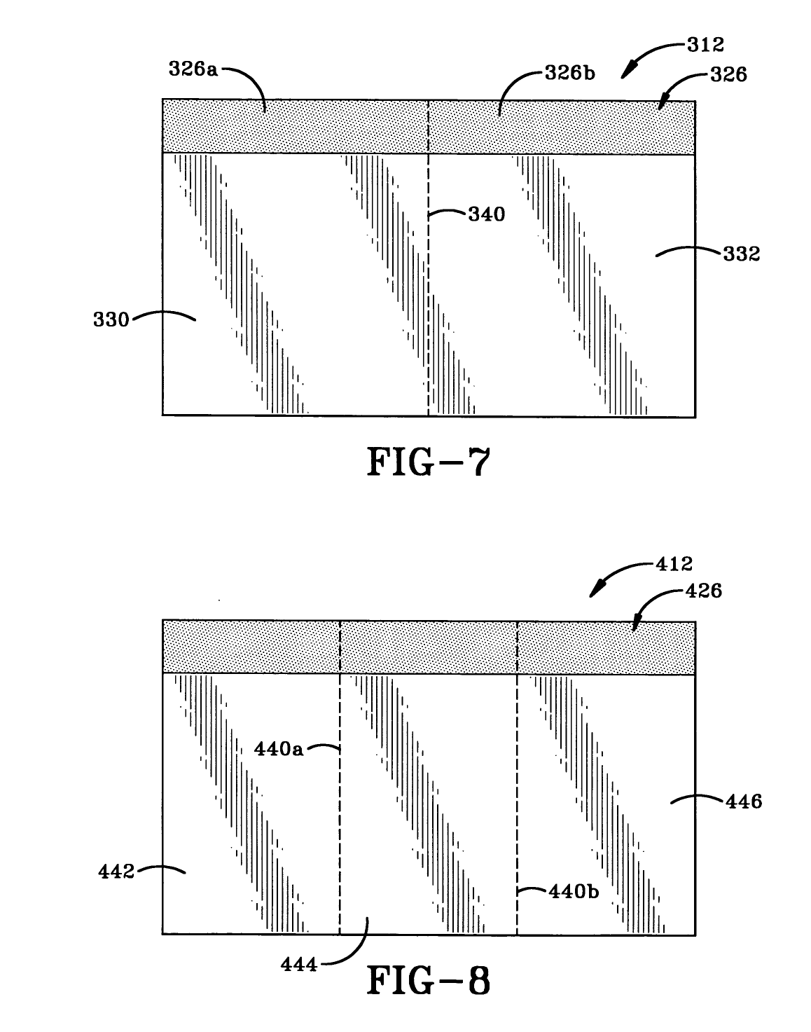

FIGS. 7 through 9, illustrate that a larger size of adhesive note 312 may be similarly perforated and provided with one or more adhesive regions which allow the note 312 to be separated into smaller sections which each have a section of adhesive region thereon. FIG. 7 shows a larger note 312 provided with one vertical row of perforations 340 and one adhesive region 326 which extends across the entire width of note 312. This note 312 may be separated into smaller sections 330 and 332 by tearing along perforations 340. Each section 330 and 332 then includes a smaller adhesive region, namely regions 326a and 326b which may be used to individually adhere sections 330 and 332 respectively to a remote object.

FIG. 8 illustrates a larger adhesive note 412 provided with two spaced apart vertical rows of perforations 440a and 440b and an adhesive region 426 which extends across the entire width of note 412. Note 412 can be separated into three smaller sections, 442, 444 and 446 which are one third the size of note 412 and each section has a section of adhesive region 426 which allows it to be adhered to a remote object.

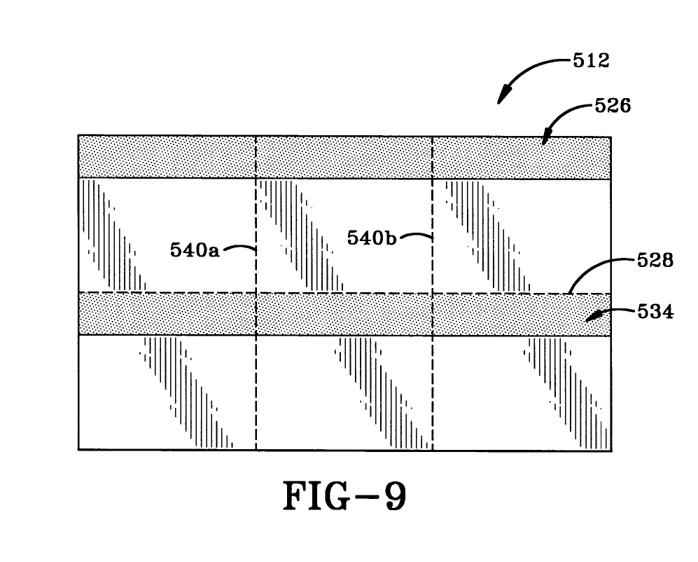

Similarly, FIG. 9 shows a larger note 512 which includes two vertical rows of perforations 540a and 540b and a horizontal row of perforations 528. Note 512 is provided with two horizontal adhesive regions 526 and 534. Note 512 may be separated along perforations 540a, 540b and 528 into as many as six individual sections which are smaller in size than note 512. Each smaller section includes a portion of one of adhesive regions 526 and 534 so that each smaller section can be adhered to a remote object. As discussed with reference to FIG. 6, the size of the smaller section being removed from note 512 can be chosen to fit the consumer's needs by simply tearing away that portion of note 512 which is needed. So, for example, the section could be as small as one sixth the size of note 512, or one third the size, or half the size or two thirds the size of note 512, etc.

It will be understood that any desired number of lines of perforations may be provided on the adhesive notes and that these perforations may lie parallel to the upper edge, perpendicular to the upper edge, at 45° to upper edge or at any other desirable angle thereto without departing from the spirit of the present invention. Furthermore, the lines of perforations may be curved or shaped in any other desired manner. It will also be understood that while the attached figures have shown the lines of perforations positioned so as to form smaller sections which are substantially equal in size and shape to each other, the lines of perforations can be positioned in such a manner that the smaller sections separable from the note can be of unequal size and shape relative to each other.

While the adhesive regions have been illustrated as lying proximate to the upper edge and proximate to the perforations on one the notes, it will be understood that the placement of the adhesive region is not restricted to these locations, but can be placed anywhere on the rear surface of the note and applied in any manner suitable so that each smaller section torn from the whole note is provided with an adhesive area which permits the smaller section to be attached to an outer surface of a remote object. Furthermore, while the adhesive region has been shown as an adhesive strip, it will be understood that discrete beads of adhesive may be utilized, or combinations of strips and beads may be used or the adhesive may be applied in any other suitable manner without departing from the spirit of the present invention.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. An adhesive note comprising:
a planar sheet having an upper edge, a lower edge, side edges, a front surface and a rear surface;
a first line of perforations formed in the sheet and along which the sheet can be separated to form a first section and a second section;
an adhesive region covering at least a portion of the rear surface of the sheet such that when the sheet is separated into the first and second sections, each of the first and second sections includes at least a part of the adhesive region.

2. The adhesive note as defined in claim 1, wherein the adhesive region is continuous.

3. The adhesive note as defined in claim 1, wherein the adhesive region is discontinuous.

4. The adhesive note as defined in claim 1, wherein the first line of perforations comprises a horizontal row of perforations lying substantially parallel to and spaced apart from the upper edge of the sheet.

5. The adhesive note as defined in claim 4, wherein the horizontal row of perforations is formed along a center line of the sheet, whereby the sheet may be separated into first and second sections of substantially equal size and shape.

6. The adhesive note as defined in claim 1, wherein the first line of perforations comprises a vertical row of perforations lying substantially perpendicular to the upper edge of the sheet.

7. The adhesive note as defined in claim 4, wherein the perpendicular row of perforations is formed along a midline of the sheet, whereby the sheet may be separated into first and second sections of substantially equal size and shape.

8. The adhesive note as defined in claim 1, further comprising a second line of perforations along which the sheet may be separated to form the first and second sections and at least a third section.

9. The adhesive note as defined in claim 8, wherein the first line of perforations comprises a first vertical row lying substantially perpendicular to the upper edge of the sheet and the second line of perforations comprises a second vertical row lying substantially perpendicular to the upper edge of the sheet and wherein the first and second vertical rows are spaced a distance apart.

10. The adhesive note as defined in claim 9, wherein the first and second vertical rows are positioned so that the sheet can be separated into first, second and third sections which are substantially equal in size and shape.

11. The adhesive note as defined in claim 10, further comprising at least a third line of perforations comprising a horizontal row lying substantially parallel to the upper edge of the sheet and intersecting the first and second vertical rows.

12. The adhesive note as defined in claim 11, wherein the horizontal row of perforations lies substantially along a center line of the sheet.

13. The adhesive note as defined in claim 8, wherein the first line of perforations comprises a vertical row lying substantially perpendicular to the upper edge of the sheet and the second line of perforations comprises a horizontal row lying substantially parallel to the upper edge of the sheet.

14. The adhesive note as defined in claim 9, wherein the vertical row of perforations lies substantially along a midline of the sheet and the horizontal row of perforations lies substantially along a center line of the sheet and the vertical and horizontal rows intersect each other at a center point of the sheet.

15. The adhesive note as defined in claim 1, wherein the adhesive extends across the sheet between the side edges and the first line of perforations passes through the adhesive region to form first and second adhesive areas.

16. The adhesive note as defined in claim 15, wherein the first and second adhesive areas are substantially equal in size.

17. The adhesive note as defined in claim 15, further comprising a second line of perforations lying substantially parallel to the first line of perforations and cutting through the adhesive region to form first, second and third adhesive areas.

18. The adhesive note as defined in claim 17, wherein the first, second and third adhesive areas are substantially equal in size.

19. The adhesive note as defined in claim 1, wherein the adhesive region comprises first and second adhesive areas that are positioned on the rear surface of the sheet and on either side of the first line of perforations.

20. The adhesive note as defined in claim 19, wherein the first and second adhesive areas lie substantially parallel to the first line of perforations.

21. The adhesive note as defined in claim 19, further comprising at least a second line of perforations which is positioned substantially perpendicular to the first line of perforations and passes through the first and second adhesive areas.

22. The adhesive note as defined in claim 20, further comprising at least a third line of perforations which is positioned substantially perpendicular to the first line of perforations and which passes through the first and second adhesive areas.
